(19) United States
(12) Patent Application Publication
(10) Pub. No.: US 2012/0009517 A1
(43) Pub. Date: Jan. 12, 2012

(54) ELECTROPHOTOGRAPHIC INK

(76) Inventors: Sivapackia Ganapathiappan, Los Altos, CA (US); Hou T. Ng, Palo Alto, CA (US)

(21) Appl. No.: 12/831,961

(22) Filed: Jul. 7, 2010

(51) Int. Cl. G03G 13/10; G03G 15/10

(52) U.S. Cl. 430/117.1; 399/237

(57) ABSTRACT

The present disclosure provides inks, systems, and methods directed towards polyurethane encapsulated pigments. In one embodiment, an electrophotographic ink can comprise an electrophotographic ink vehicle and a polyurethane encapsulated pigment. The polyurethane encapsulated pigment can comprise a pigment and a polyurethane, wherein the polyurethane fully encapsulates the pigment and forms the outer-surface of the polyurethane encapsulated pigment with a surface roughness of less than 100 nm. Additionally, the electrophotographic ink can have a residual monomer content of less than 0.01 wt % of the electrophotographic ink.

### BACKGROUND

Digital printing involves technologies in which a printed image is created directly from digital data, for example using electronic layout and/or desktop publishing programs. Some known methods of digital printing include full-color ink-jet printing, electrophotographic printing, laser photo printing, and thermal transfer printing.

Electrophotographic printing techniques involve the formation of a latent image on a photoconductor surface mounted on an imaging plate. The photoconductor is first sensitized to light, usually by charging with a corona discharge, and then exposed to light projected through a positive film of the document to be reproduced, resulting in dissipation of the charge in the areas exposed to light. The latent image is subsequently developed into a full image by the attraction of oppositely charged toner particles to the charge remaining on the unexposed areas. The developed image is transferred from the photoconductor to a rubber offset blanket, from which it is transferred to a substrate, such as paper, plastic or other suitable material, by heat or pressure or a combination of both to produce the printed final image.

The latent image is developed using either a dry toner (a colorant mixed with a powder carrier) or a liquid ink (a suspension of a colorant in a liquid carrier). The toner or ink generally adheres to the substrate surface with little penetration into the substrate. The quality of the final image is largely related to the size of the particles, with higher resolution provided by smaller particles.

Dry toners used in solid electrophotography are fine powders with a relatively narrow particle size distribution that are expelled from fine apertures in an application device. A typical dry toner is predominantly composed of a heat-sensitive polymer (e.g., acrylic, styrene) and a pigment such as carbon black with a solid carrier, typically resin coated iron or steel powders. Variations in particle shape and charge-to-mass ratio as well as dust particles found in the dry ink may cause technical difficulties during the printing process. Larger or irregularly shaped particles can cause blockage while dust particles that are too small to hold a sufficient charge to be controllable adhere to the print head surface.

Liquid inks used in liquid electrophotography are generally comprised of pigment- or dye-based thermoplastic resin particles suspended in a non-conducting liquid carrier, generally a saturated hydrocarbon. Offset-preventing and release-facilitating oil, such as silicone oil, is often used to increase the efficiency of ink transfer from the imaging surface. The liquid ink is electrophotographically charged and brought into contact with the photoconductor surface to develop the latent image. When transferred to an offset blanket and heated, the particles melt and fuse to form a tacky polymer film. When the tacky polymer film comes in contact with a cooler surface, such as a paper or other substrate, the film hardens and adheres to the substrate and peels away from the blanket, laminating the substrate. The ink is deposited onto the substrate essentially dry, and desired print finishing can be performed immediately. Since the ink is transferred essentially completely from the blanket to the substrate, a new layer, such as of a different color, can be created for every rotation of the press.

### DETAILED DESCRIPTION

Before the present disclosure described if further detail, it is to be understood that this disclosure is not limited to the particular process steps and materials disclosed herein because such process steps and materials may vary somewhat. It is also to be understood that the terminology used herein is used for the purpose of describing particular embodiments only. The terms are not intended to be limiting because the scope of the present disclosure is intended to be limited only by the appended claims and equivalents thereof.

It is noted that, as used in this specification and the appended claims, the singular forms “a,” “an,” and “the” include plural referents unless the context clearly dictates otherwise.

As used herein, “electrophotographic ink vehicle” refers to a solvent or combination of cosolvents and other liquids (which contains the colorant), and which is formulated for electrophotographic printing. In addition to the solvent or co-solvents, other liquid ingredients can be included, such as, without limitation, surfactants, charge control agents, buffers, biocides, viscosity modifiers, sequestering agents, stabilizing agents, and anti-kogation agents. Though not part of the electrophotographic ink vehicle per se, in addition to the pigment, the liquid vehicle can include a dispersant for the pigment and can further carry solid additives such as polymers, latexes, UV curable materials, plasticizers, salts, charge control agents etc.

As used herein, “solvent(s)” or “co-solvent(s)” refers to the fluid in which the pigment of the present disclosure can be dispersed to form a pigment dispersion and, in some embodiments, in which a polyurethane can be formed. Such solvent(s) or co-solvent(s) can be formulated into an electrophotographic ink vehicle appropriate for electrophotographic printing where the electrophotographic ink vehicle has a viscosity and conductivity for such printing. The solvent or solvents may be admixed with a variety of different agents to form an electrophotographic ink vehicle. It is noted that when referring generally to “solvent,” it is understood that one solvent or multiple co-solvents can be present.

As used herein, “pigment” generally includes pigment colorants, magnetic particles, aluminas, silicas, and/or other ceramics, organo-metallics or other opaque particles, whether or not such particulates impart color. Thus, though the present description primarily exemplifies the use of pigment colorants, the term “pigment” can be used more generally to describe not only pigment colorants, but other pigments such as organometallics, ferrites, ceramics, etc. In one specific embodiment, however, the pigment is a pigment colorant.

As used herein, “surface roughness” refers to a measure of the roughness of a surface as determined by the difference in height between the highest peak on the surface and the lowest valley on the surface.

As used herein, “substituted” means that a hydrogen atom of a compound or moiety is replaced by another atom such as a carbon atom or a heteroatom, which is part of a group referred to as a substituent. Substituents include, for example, alkyl, alkoxy, aryl, aryloxy, alkenyl, alkenoxy, alkynyl, alkynoxy, thioalkyl, thioalkenyl, thioalkynyl, thioaryl, etc.

As used herein, “heteroatom” refers to nitrogen, oxygen, halogens, phosphorus, or sulfur.

As used herein, “alkyl” refers to a branched, unbranched, or cyclic saturated hydrocarbon group, which typically, although not necessarily, contains from 1 to about 50 carbon atoms, or 1 to about 40 carbon atoms, or 1 to about 30 carbon atoms, for example. Alkyls include, but are not limited to, methyl, ethyl, n-propyl, isopropyl, n-butyl, isobutyl, t-butyl, octyl, and decyl, for example, as well as cycloalkyl groups such as cyclopentyl, and cyclohexyl, for example. The term “lower alkyl” refers to an alkyl group having from 1 to 6 carbon atoms. The term “higher alkyl” refers to an alkyl group having more than 6 carbon atoms, for example, 7 to about 50 carbon atoms, or 7 to about 40 carbon atoms, or 7 to about 30 carbon atoms or more. As used herein, “substituted alkyl” refers to an alkyl substituted with one or more substituent groups. The term “heteroalkyl” refers to an alkyl in which at least one carbon atom is replaced with a heteroatom. If not otherwise indicated, the term “alkyl” includes unsubstituted alkyl, substituted alkyl, lower alkyl, and heteroalkyl.

As used herein, “aryl” refers to a group containing a single aromatic ring or multiple aromatic rings that are fused together, directly linked, or indirectly linked (such that the different aromatic rings are bound to a common group such as a methylene or ethylene moiety). Aryl groups described herein may contain, but are not limited to, from 5 to about 50 carbon atoms, or 5 to about 40 carbon atoms, or 5 to 30 carbon atoms or more. Aryl groups include, for example, phenyl, naphthyl, anthryl, phenanthryl, biphenyl, diphenylether, diphenylamine, and benzophenone. The term “substituted aryl” refers to an aryl group comprising one or more substituent groups. The term “heteroaryl” refers to an aryl group in which at least one carbon atom is replaced with a heteroatom. If not otherwise indicated, the term “aryl” includes unsubstituted aryl, substituted aryl, and heteroaryl.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not only the explicitly recited values of about 1 wt % to about 5 wt %, but also include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

It has been recognized that a pigment can be fully encapsulated with polyurethane to provide a substantially spherical particle having low residual monomer content. In other words, the polyurethane encapsulated pigment disclosed herein can be used in electrophotographic inks for electrophotographic printing to provide durable printed images with pigments having improved charging properties. These types of compositions typically have significantly different characteristics than traditional aqueous based ink-jet inks. As such, the present inks can provide an acceptable viscosities and conductivity for electrophotographic printing in addition to providing durable printed images.

In accordance with this, the present disclosure is drawn to electrophotographic ink compositions, systems, and methods, where the electrophotographic ink generally comprises an electrophotographic ink vehicle and a polyurethane encapsulated pigment. It is noted that when discussing the present compositions, systems, and associated methods, each of these discussions can be considered applicable to each of these embodiments, whether or not they are explicitly discussed in the context of that embodiment. Thus, for example, in discussing a solvent for use in an electrophotographic ink, such a solvent can also be used for a method of making the electrophotographic ink or a system for printing an electrophotographic ink, and vice versa.

As such, an electrophotographic ink can comprise an electrophotographic ink vehicle and a polyurethane encapsulated pigment comprising a pigment and a polyurethane, wherein the polyurethane fully encapsulates the pigment and forms the outer-surface of the polyurethane encapsulated pigment with a surface roughness of less than 100 nm. Additionally, the electrophotographic ink can have a residual monomer content of less than 0.01 wt % of the electrophotographic ink. Additionally, the electrophotographic ink can have a low field conductivity of less than 200 pS/cm and a viscosity from about 0.5 to about 40 cps.

A method of manufacturing an electrophotographic ink can comprise combining a polyurethane encapsulated pigment with an electrophotographic ink vehicle. The polyurethane encapsulated pigment can comprise a pigment and a polyurethane formed in situ by dispersing the pigment in a solvent, adding a polyol and a polyisocyanate to the solvent, and polymerizing the polyol and polyisocyanate to form the polyurethane that fully encapsulates the pigment and forms the outer-surface of the polyurethane encapsulated pigment with a surface roughness of less than 100 nm.

A system for printing an electrophotographic ink can comprise an electrophotographic printer and an electrophotographic ink. The electrophotographic ink can be any electrophotographic ink described herein. The system can further comprise a recording medium for receiving the electrophotographic ink when printed thereon using the electrophotographic printer.

Generally, the electrophotographic ink vehicle can include an aliphatic solvent including substituted or unsubstituted, linear or branched, aliphatic compounds. Additionally, such solvents can include aryl substituents. In one embodiment, the aliphatic solvent can be substantially nonaqueous, e.g., containing less than 0.5% water. In another embodiment, the aliphatic solvent can be nonaqueous. The aliphatic solvent can comprise a member selected from the group of paraffins, isoparaffins, oils, alkanes having from about 6 to about 100 carbon atoms, and mixtures thereof.

In one embodiment, such inks can include at least one aliphatic hydrocarbon, such as a paraffin and/or isoparaffin. As such, the aliphatic solvent can comprise, or even consist essentially of isoparaffins, such as or equivalent to the ISOPAR® high-purity isoparaffinic solvents with narrow boiling ranges marketed by Exxon Mobil Corporation (Fairfax, Va., USA). Also suitable as an aliphatic solvent, or cosolvent, for implementing embodiments of the present disclosure are alkanes having from about 6 to about 14 carbon atoms such as solvents sold under the NORPAR® (NORPAR® 12, 13 and 15) tradename available from Exxon Mobil Corporation (Fairfax, Va., USA). Other hydrocarbons for use as an aliphatic solvent, or cosolvent, are sold under the AMSCO® (AMSCO® 460 and OMS) tradename available from American Mineral Spirits Company (New York, N.Y., USA), under the SOLTROL® tradename available from Chevron Phillips Chemical Company LLC (The Woodlands, Tex., USA) and under the SHELLSOL® tradename available from Shell Chemicals Limited (London, UK). Such an aliphatic solvent, or cosolvent, can have desirable properties such as low odor, lack of color, selective solvency, good oxidation stability, low electrical conductivity, low skin irritation, low surface tension, superior spreadability, narrow boiling point range, non-corrosive to metals, low freeze point, high electrical resistivity, high interfacial tension, low latent heat of vaporization and low photochemical reactivity.

Generally, the electrophotographic inks described herein can have a viscosity ranging from about 0.5 to about 40 cps. In one embodiment, the present electrophotographic inks can have a viscosity from about 3 cps to about 10 cps. Additionally, the electrophotographic inks can have a conductivity of less than about 200 pS/cm. In one embodiment, the electrophotographic inks can have a conductivity of less than about 100 pS/cm, or in another embodiment, even less than 85 pS/cm.

Generally, the pigments used herein can be any colored pigments and non-colored pigments. In one embodiment, the pigment can be selected from the group of black pigment, white pigment, yellow pigment, cyan pigment, magenta pigment, and mixtures thereof. The pigment can be present in the electrophotographic ink from about 0.01 wt % to about 15 wt % of the electrophotographic ink. In one embodiment, the pigment can be present from about 0.1 wt % to about 5 wt % of the electrophotographic ink.

Generally, the pigments described herein can be encapsulated with polyurethane. The polyurethane can be formed from any polyol and polyisocyanate. In one embodiment, at least one of the polyol and polyisocayante can be difunctional. In another embodiment, the polyol can be a diol and/or the polyisocyanate can be a diisocyanate. In another embodiment, some amount of monomeric aliphatic alcohol or phenolic derivatives can be used to adjust the reactivity and pendant side chain for steric stabilization of the particle. The polyurethane generally comprises the outer-surface of the encapsulated pigment. In one embodiment, the polyurethane encapsulated pigment can exclude acrylates. In another embodiment, the polyurethane can include urea derivatives. Additionally, the polyurethane can have a C₈-C₅₀ backbone, i.e., where the backbone of the polyurethane between at least one set of polyurethane linkages has 8 to 50 consecutively covalently bonded carbon atoms, which can be substituted or unsubstituted. In one embodiment, the polyurethane can have a C₁-C₅₀ side chain; i.e., the polyurethane can have a pendent group off of the backbone having 1 to 50 consecutively covalently bonded carbon atoms, which can be substituted or unsubstituted. In another embodiment, the polyurethane can have a C₈ to C₂₄ side chain.

The polyisocyantes described herein can include polymeric isocyanates, diisocyanates, thiocyanates, and isothiocyanates. For example, a commercially available polymeric isocyanate that can be used in the present polyurethanes is N-75 from BASF. The use of a polyfunctional monomer can provide a means to cross-link the polyurethane. In one embodiment, the polyurethane can be cross-linked. The diisocyanates described herein can be selected from the group of methylene diphenyl diisocyanate, hexamethylene diisocyanate, p-tetramethyl xylene diisocyanate, m-tetramethyl xylene diisocyanate, bitolylene diisocyanate, toluene diisocyanate, methylene-bis(4-cyclohexyl)diisocyanate, p-phenylene diisocyanate, isophorone diisocyanate, 1,4-diisocyanatobutane, 1,5-naphthalene diisocyanate, 1,6-diisocyanatohexane, 1,12-diisocyanatododecane, 1,5-diisocyanato-2-methylpentane, 1,8-diisocyanatooctane, and mixtures thereof.

Generally, the polyol can be any type of polyfunctional alcohol including, for example, diols and triols. In one embodiment, the polyol can be selected from the group of polycaprolactone diol; ethylene glycol; polyethylene glycol; propylene glycol; polypropylene glycol; butylene glycol; polybutylene glycol; tetramethylene glycol; polytetramethylene glycol; poly(ethylene oxide) polymers; poly(propylene oxide) polymers; poly(tetramethylene oxide) polymers; copolymers thereof having terminal hydroxyl groups derived from polyhydric compounds including diols and triols; and combinations thereof. The monomeric aliphatic alcohol or phenolic derivatives that can be used include 1-hexanol, 2-hexanol, 1-octanol, 2-octanol, 1-dodecanol, 1-hexadecanol, phenol, cresols, benzyl alcohol, bisphenol-A, and combinations thereof.

Generally, the polyurethane can include a polyisocyante portion, referred to as the hard segment, and a polyol, referred to as the soft segment. Additionally, the polyurethane can comprise an acid polyol. In one embodiment, the polyurethane can include chain extenders. A chain extender is any compound capable of polymerizing with the polyisocyanate such that the chain extender resides in the hard segment of the polyurethane. The chain extender can be any compound having a molecular weight of less than 500 M_{w} that resides in the hard segment that is not a polyisocyanate. It is noted that the molecular weights described herein refer to weight average molecule weights unless otherwise stated.

Generally, the polyurethane encapsulated pigment can be polymerized in situ by dispersing the pigment in a solvent, adding a polyol and a polyisocyanate to the solvent, and polymerizing the polyol and polyisocyanate to form the polyurethane. In one embodiment, the solvent can be the electrophotographic ink vehicle. In another embodiment, the solvent can be the same as a solvent used in the electrophotographic ink vehicle. Additionally, polyamines, including diamines, can be added to the solvent to form a polyurethane having urea derivatives. Generally, the polyurethane reactions can be free of radical polymerization processes. In addition to the above, stabilizers and/or catalysts can be added. Stabilizers can include, without limitation, polyvinylpyrrolidone (PVP), polyvinyl alcohol (PVA), alkyl celluloses, and mixtures thereof. Additionally, catalysts can include, without limitation, dibutyltin diluarate and tertiary amines such as triethylamine or tri-n-butylamine.

The electrophotographic inks described herein can have a low residual monomer content and a low surface roughness. In one embodiment, the residual monomer content can be less than 0.001 wt % of the electrophotographic ink.

Further, in one embodiment, the polyurethane encapsulated pigment can have a surface roughness of less than 50 nm. Additionally, the present disclosure can provide a polyurethane encapsulated pigment having a surface roughness of from about 10 nm to about 100 nm. In one embodiment, the surface roughness can be less than 25 nm. In another embodiment, the surface roughness can be less than 10 nm.

The polyurethane encapsulated pigments described herein can have a final particle size from about 250 nm to about 20,000 nm. Additionally, the polyurethane can have a thickness of about 10 nm to about 10,000 nm. In one embodiment, the thickness can be from about 20 nm to 2,000 nm. The polyurethane encapsulated pigments can be formulated to provide a specific T_{g}. The T_{g} can be manipulated by increasing the number of carbons along the backbone of the polyurethane as well as increase the amount of urea derivative in the polyurethane. In one embodiment, the T_{g} can be from about 0° C. to about 150° C. In another embodiment, the T_{g} can be from about 50° C. to about 80° C. Such T_{g} values can allow for desired film formation after printing.

The electrophotographic ink vehicle can also comprise a surfactant. In one embodiment, the surfactant can be stearic acid, dioctylsulfosuccinate, dioctylbenzenesulfonic acid and sodium dodecylsulfate. In another embodiment, the surfactant can be a nonionic surfactant. Suitable surfactants that can be used include alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, and the like. The amount of surfactant added to the electrophotographic inks can range from 0.01 wt % to 10 wt %.

The electrophotographic ink compositions of the present disclosure can also be suitable for use on many types of substrates of recording media, including but not limited to vinyl media, cellulose-based paper media, various cloth materials, polymeric materials (non-limitative examples of which include polyester white film or polyester transparent film), photopaper (non-limiting examples of which include polyethylene or polypropylene extruded on one or both sides of paper), metals, and/or mixtures or composites thereof. A non-limiting example of a suitable metal material is a metal in foil form made from, for example, at least one of aluminum, silver, tin, copper, ceramics, alloys thereof, and/or mixtures thereof. In one embodiment, the recording medium can include paper or specially coated media.

The present electrophotographic ink vehicles can include a solvent or moltiple co-solvents present in total at from 0.1 wt % to 30 wt %, depending on the jetting architecture, though amounts outside of this range can also be used. In addition to the pigment and solvent(s), e.g., aliphatic solvent, the balance of the formulation can include other vehicle components known in the art, such as biocides, viscosity modifiers, materials for pH adjustment, sequestering agents, preservatives, and the like. The jetting architecture that can be used with the inks of the present disclosure includes thermal and piezoelectric print heads for electrophotographic printing applications.

Classes of co-solvents that can be used can include organic co-solvents including aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like.

Consistent with the formulation of this disclosure, various other additives may be employed to optimize the properties of the ink composition for specific applications. Sequestering agents, such as EDTA (ethylene diamine tetra acetic acid), may be included to eliminate the deleterious effects of heavy metal impurities, and buffer solutions may be used to control the pH of the ink. From 0 wt % to 2 wt %, for example, can be used. Viscosity modifiers and buffers may also be present, as well as other additives known to those skilled in the art to modify properties of the ink as desired. Such additives can be present at from 0 wt % to 20 wt %.

### EXAMPLES

The following examples illustrate a number of embodiments of the present compositions, systems, and methods that are presently known. However, it is to be understood that the following are only exemplary or illustrative of the application of the principles of the present compositions, systems, and methods. Numerous modifications and alternative compositions, methods, and systems may be devised by those skilled in the art without departing from the spirit and scope of the present systems and methods. The appended claims are intended to cover such modifications and arrangements. Thus, while the present compositions, systems, and methods have been described above with particularity, the following examples provide further detail in connection with what are presently deemed to be the acceptable embodiments.

### Example 1

### Polyurethane Encapsulated Pigment

A polyurethane encapsulated pigment was manufactured by dispersing a pigment and then encapsulating the pigment as described below. The pigment dispersion was performed by first, mixing 9.5 g of Carbon black from Degussa Corp (XPB-306) with 20 g of Isopar® L, an isoparaffinic solvent, and 0.5 g of aluminum stearate. Next, 60 g of zirconia beads of 1 mm diameter was added to the mixture and shaken well with paint shaker for 4 hours to obtain a pigment dispersion in Isopar L. Encapsulation was accomplished by mixing the above pigment dispersion (4.08 g) with polycaprolactone diol of molecular weight 530 (1.41 g), methylenebis(phenyl isocyanate) (0.65 g) and dibutyltin dialuarate (0.01 g). This mixture was heated to 60° C. for 4 hours. The urethane formation occurred and encapsulated particles were obtained. The particle size obtained was can be up to a microns, but can be reduced easily by introducing stabilizers. The stabilizers can be polymers that are soluble in the medium and increase the solubility of the growing polymer chain during polymerization. In this example, other dispersing equipment can be used by replacing paint shaker to obtain dispersion. Examples of dispersing equipment that can be used include a microfluidizer available from Microfluidic Corporation, or an ultrasonicator available from Branson and Dispermats available from BYK Gardner.

### Example 2

### Electrophotographic Ink

An electrophotographic ink is made by diluting the dispersion obtained from Example 1 (4 g) with isopar L (96 g).

### Example 3

### Polyurethane Encapsulated Pigment

Example 1 is repeated under similar conditions, replacing methylenebis(phenyl isocyanate) with poly(isocyanate) N-75 in the same amount. An encapsulated pigment is produced having a particle size of 2 to 5 microns and a Tg of 50° C. to 80° C.

While the disclosure has been described with reference to certain preferred embodiments, those skilled in the art will appreciate that various modifications, changes, omissions, and substitutions can be made without departing from the spirit of the disclosure. It is intended, therefore, that the disclosure be limited only by the scope of the following claims.

What is claimed is:

1. An electrophotographic ink, comprising
an electrophotographic ink vehicle; and
a polyurethane encapsulated pigment comprising a pigment and a polyurethane, wherein the polyurethane fully encapsulates the pigment and forms the outer-surface of the polyurethane encapsulated pigment with a surface roughness of less than 100 nm;
wherein the electrophotographic ink has a residual monomer content of less than 0.01 wt % of the electrophotographic ink.

2. The electrophotographic ink of claim 1, wherein the polyurethane encapsulated pigment excludes acrylates.

3. The electrophotographic ink of claim 1, wherein the polyurethane includes urea derivatives.

4. The electrophotographic ink of claim 1, wherein the electrophotographic ink has a residual monomer content of less than 0.001 wt % of the electrophotographic ink and the polyurethane encapsulated pigment has a surface roughness of less than 50 nm.

5. The electrophotographic ink of claim 1, wherein the polyurethane has a C₈-C₅₀ backbone.

6. The electrophotographic ink of claim 1, wherein the polyurethane has a C₁-C₅₀ side chain.

7. The electrophotographic ink of claim 1, wherein the polyurethane is polymerized from a polyol selected from the group of polycaprolactone diol, ethylene glycol, polyethylene glycol, propylene glycol, polypropylene glycol, butylene glycol, polybutylene glycol, tetramethylene glycol, polytetramethylene glycol, poly(ethylene oxide) polymers, poly(propylene oxide) polymers, poly(tetramethylene oxide) polymers, copolymers thereof having terminal hydroxyl groups derived from polyhydric compounds including diols and triols, and combinations thereof; and a polyisocyanate selected from the group of polymeric isocyanates, diisocyanates, thiocyanates, and isothiocyanates, and combinations thereof.

8. The electrophotographic ink of claim 1, wherein the polyurethane is cross-linked.

9. The electrophotographic ink of claim 1, wherein the polyurethane has a thickness of about 10 nm to about 10,000 nm.

10. The electrophotographic ink of claim 1, wherein the polyurethane encapsulated pigment has a particle size of about 250 nm to about 20,000 nm.

11. The electrophotographic ink of claim 1, wherein the polyurethane encapsulated pigment is polymerized in situ by
dispersing the pigment in solvent,
adding a polyol and a polyisocyanate to the solvent, and
polymerizing the polyol and polyisocyanate to form the polyurethane.

12. The electrophotographic ink of claim 11, wherein the solvent is the electrophotographic ink vehicle.

13. The electrophotographic ink of claim 11, wherein one or more solvent is the same as a solvent used in the electrophotographic ink vehicle.

14. A method of manufacturing an electrophotographic ink, comprising combining a polyurethane encapsulated pigment with an electrophotographic ink vehicle, the polyurethane encapsulated pigment comprising a pigment and a polyurethane and formed in situ by:
dispersing the pigment in solvent,
adding a polyol and a polyisocyanate to the solvent, and
polymerizing the polyol and polyisocyanate to form the polyurethane that fully encapsulates the pigment and forms the outer-surface of the polyurethane encapsulated pigment with a surface roughness of less than 100 nm;
wherein the electrophotographic ink has a residual monomer content of less than 0.01 wt % of the electrophotographic ink.

15. The method of claim 14, wherein the polyurethane is formed in situ by adding a polyamine in addition to the polyol and the polyisocyanate thereby forming a urea derivative.

16. The method of claim 14, wherein the method is free of radical polymerization processes.

17. The method of claim 14, wherein the solvent is the electrophotographic ink vehicle.

18. The method of claim 14, wherein the solvent is the same as a solvent used in the electrophotographic ink vehicle.

19. A system for printing an electrophotographic ink, comprising
an electrophotographic printer;
an electrophotographic ink, comprising:
an electrophotographic ink vehicle;
a polyurethane encapsulated pigment comprising a pigment and a polyurethane, wherein the polyurethane fully encapsulates the pigment and forms the outer-surface of the polyurethane encapsulated pigment with a surface roughness of less than 100 nm;
wherein the electrophotographic ink has a residual monomer content of less than 0.01 wt % of the electrophotographic ink.

20. The system of claim 19, further comprising a recording medium which includes paper.
